(19) United States
(12) Patent Application Publication
(10) Pub. No.: US 2015/0360595 A1
(43) Pub. Date: Dec. 17, 2015

(54) SEAT FOR A MOTOR VEHICLE

(71) Applicant: GM GLOBAL TECHNOLOGY OPERATIONS LLC, Detroit, MI (US)

(72) Inventors: Jonas EISENBRAUN, Ruesselsheim (DE); Christine SUCHY, Hochheim am Main (DE)

(73) Assignee: GM GLOBAL TECHNOLOGY OPERATIONS LLC, Detroit, MI (US)

(21) Appl. No.: 14/742,043

(22) Filed: Jun. 17, 2015

(30) Foreign Application Priority Data
Jun. 17, 2014 (DE) 102014008627.5

(51) Int. Cl. B60N 2/58; B60N 2/68; B60N 2/64

(52) U.S. Cl. CPC B60N 2/5816; B60N 2/64; B60N 2/68

(57) ABSTRACT

A seat for a motor vehicle includes a seat bottom, a seat back with a seat cover, an upholstery, an A-support structure and a B-support structure. The A-section of the seat cover lies on the upholstery, and a B-section of the seat cover is fastened to the B-support structure. The seat back exhibits a height extension between an upper end and lower end of the seat back. The A-section and B-section of the seat cover are fastened to a A-fixing strip, which is arranged on a back area of the seat back. The distance in the direction of the height extension between an upper end of the A-fixing strip and the upper end of the seat back is greater than 40% of the height extension of the seat back, so as to yield legroom on the back side of the seat back without the A-fixing strip.

This application claims priority to German Patent Application No. 102014008627.5, filed Jun. 17, 2014, which is incorporated herein by reference in its entirety,

### TECHNICAL FIELD

The present disclosure pertains to a seat for a motor vehicle and a motor vehicle.

### BACKGROUND

Motor vehicles exhibit an interior, and seats are arranged within the interior. Front seats generally exhibit a seat part or seat bottom and back part or seat back, which can be pivoted around a swivel axis. Rear seats are arranged behind the front seats within the interior of the motor vehicle. The rear seats are generally combined into a rear seat bench having three seating positions. The seat back of the front seats exhibits a front side, and a back side lying opposite the front side. The back side of the seat back of the front seats poses a limitation to the knee of individuals or passengers seated in the rear seating positions. A partial area of the back side of the seat back. thus represents legroom, within which the knees of individuals on the rear seat are arranged.

As the support structure, the seat back encompasses an A-support structure and a B-support structure, The A-support structure is generally designed as a strut, and the B-structure is normally designed as a wire frame. The seat back further encompasses an upholstery and seat cover. The seat cover is divided into an A-section and B-section. The B-section of the seat cover is fastened by means of a B-fixing strip to the B-support structure, i.e., to the wire frame. An end area of the A-section of the seat cover and an end area of the B-section of the seat cover are joined together by means of two A-fixing strips. To this end, the A-section and B-section of the seat cover are joined at the end area with the A-fixing strip by means of a seam. The A-fixing strip is covered by the seat cover, meaning arranged between the seat cover and upholstery. The A-fixing strips exhibit an upper end, and the upper end of the A-fixing strips exhibits a small distance to an upper end of the seat back. As a result, the A-fixing strip is guided or arranged up to the legroom on the back side of the seat back, so that when the knee of a passenger contacts or lies against the rear seat, the A-fixing strip forms an uncomfortable stop or limit for the knee of an individual on the rear seat.

### SUMMARY

In accordance with the present disclosure a seat for a motor vehicle is provides that offer a more comfortable legroom behind the seat. The seat includes a seat bottom, a seat back with a seat cover, an upholstery, an A-support structure and B-support structure. An A-section of the seat cover lies at least partially on the upholstery. A B-section of the seat cover is directly or indirectly fastened at least partially to the B-support structure. The seat back exhibits a height extension between an upper end and lower end of the seat back. At least one A-fixing strip is arranged on a back area of the seat back and fastens with the A-section and B-section of the seat cove. The A-fixing strip exhibits an upper end and lower end. The distance in the direction of the height extension between the upper end of the A-fixing strip and the upper end of the seat back is greater than 40% of the height extension of the seat back, so as to yield legroom on the back side of the seat back without the A-fixing strip. The upper end of the A-fixing strip thus exhibits a large distance in relation to the upper end of the seat back, so that the A-fixing strip on the hack side of the seat back is thereby arranged outside of the legroom. For this reason, the A-fixing strip advantageously does not form a stop or limit for the knees of individuals on the rear seats, thereby making the legroom on the back side of the seat back significantly more comfortable.

In an additional embodiment, the distance in the direction of height extension between the upper end of the A-fixing strip and the upper end of the seat back is greater than 45%, 50%, 55%, 60%, 65% or 70% of the height extension of the seat back. In a supplementary variant, the distance in the direction of height extension between the upper end of the A-fixing strip and the upper end of the seat back is greater than 40%, 45%, 50%, 55%, 60%, 65% or 70% of the height extension of the seat back for all A-fixing strips.

It makes sense for the length of the A-fixing strip to be greater than 20% or 30% of the height extension of the seat back and/or for an end area of the A-section of the seat cover and an end area of the B-section of the seat cover to be fastened to the A-fixing strip. In a supplementary embodiment, the length of the A-fixing strip is less than 40%, 45%, 50%, 55%, 60%, 65% or 70% of the height extension of the seat back, and/or the distance in the direction of height extension between the lower end of the A-fixing strip and the lower end of the seat back is less than 30%, 20%, 10%, 5% or 2% of the height extension of the seat back.

In an additional variant, the A-fixing strip is fastened to the upholstery and/or to the A-support structure, and/or the one A-fixing strip is arranged between the seat cover and upholstery.

It is preferable for the seat back to exhibit two A-fixing strips, and for the two A-fixing strips to be arranged spaced apart at a distance in the direction of a width extension of the seat back. In particular as viewed in a horizontal section, the A-section and B-section of the seat cover each exhibit two end areas, and one respective end area of the A- and B-section of the seat cover is joined with a first A-fixing strip, while another end area of the A-section and B-section of the seat cover is joined with the second A-fixing strip. As a consequence, two A-fixing strips are required for joining the end areas of the A-section and B-section of the seat cover.

In a further embodiment, the seat back includes at least one B-fixing strip, and preferably two B-fixing strips. The B-section of the seat cover, in particular only the B-section in relation to the seat cover, is fastened to the B-fixing strip, The B-fixing strip is required so as to also be able to reliably fasten the B-section of the seat cover indirectly to the B-support structure. In an additional embodiment, the at least one B-fixing strip is fastened to the B-support structure.

In a supplementary embodiment, an upper end of the B-fixing strip ends in a differential pitch in the direction of the height extension relative to the upper end of the at least one A-fixing strip, and the upper end of the B-fixing strip preferably ends above the upper end of the A-fixing strip. In a further embodiment, the differential pitch is greater than 2%, 5%, 10%, 20% or 30% of the height extension of the seat back.

In an additional variant, the A-section and B-section of the seat cover are fastened to the A-fixing strip by means of a seam. it is best for the B-fixing strip to be fastened to the B-support structure with hooks, and/or for the B-section of the seat cover to be joined with the B-fixing strip by means of a seam.

In a supplementary embodiment, the A-support structure has a stiff design, and/or the A-support structure encompasses two struts, preferably made out of metal, and/or the B-support structure has a flexible and/or elastic design. For example, the B-support structure is designed as a wire frame or an elastic matt, and/or the B-support structure is formed in a direction of the width extension of the seat back between the A-support structure, and in particular the two struts, in a horizontal section or in a section perpendicular to the direction of the height extension of the seat back, and/or the seat back can be pivoted around a preferably horizontal swivel axis.

A motor vehicle according to the present disclosure, encompasses a body, a powertrain, in particular an internal combustion engine and/or an electric engine, and at least one seat, wherein the seat is formed as a seat described herein.

### BRIEF DESCRIPTION OF THE DRAWINGS

The present disclosure will hereinafter be described in conjunction with the following drawing figures, wherein like numerals denote like elements.

FIG. 1 is a side view of a motor vehicle;

FIG. 2 is a longitudinal section of a front seat of the motor vehicle;

FIG. 3 is a rear view of a back section of a front seat according to FIG. 2;

FIG. 4 is a section A-A according to FIG. 3 of the seat back; and

FIG. 5 is a section B-B according to FIG. 3 of the seat back.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

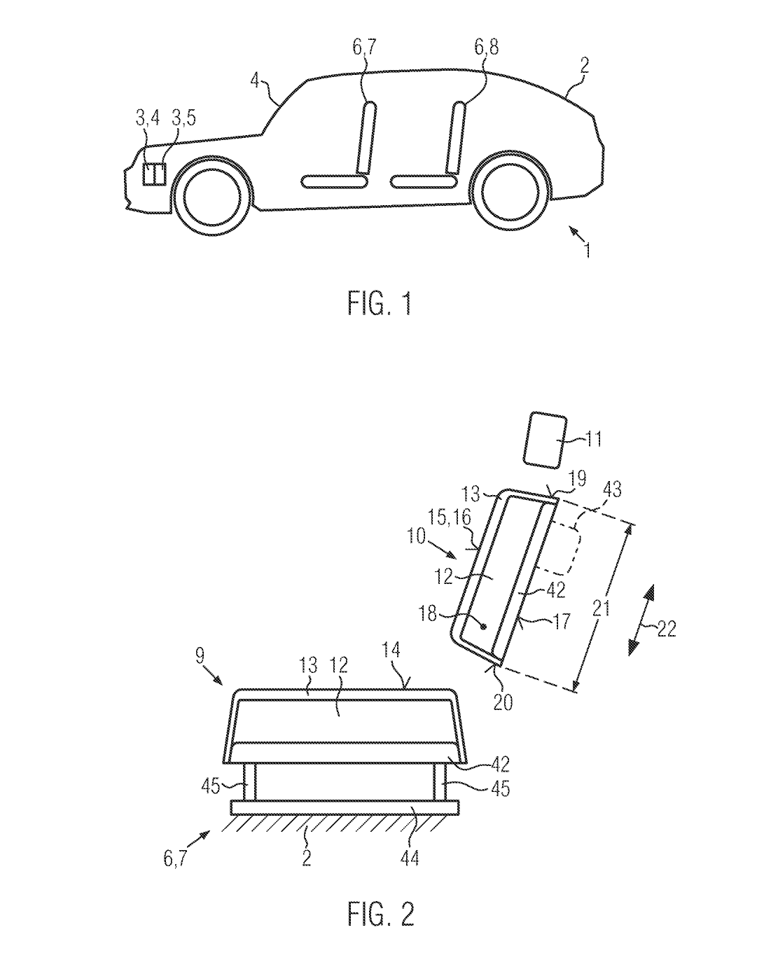

A motor vehicle 1 shown in FIG. 1 exhibits a body 2 made out of metal, in particular steel. The motor vehicle I is moved by a powertrain 3, for example an electric engine 4 and/or an internal combustion engine 5. The body 2 encloses an interior volume or occupant compartment having arranged within it two front seats 7 as seats 6, as well as three rear seats 8 as seats 6. The three rear seats 8 may be here combined into a single bench.

FIG. 2 presents a longitudinal section through the front seat 7. The front seat 7 encompasses a seat part or seat bottom 9 and a back part or seat back 10. The seat bottom 9 and seat back 10 each exhibit a support structure 42, to which an upholstery 12 and a seat cover 13 are fastened. A headrest 11 is also fastened to the seat back 10. The seat bottom 9 is fastened to a rail 44 by means of support feet 45, and the rail 44 is fastened to the body 2. The support feet 45 fastened to the rail 44 can here be used to horizontally move the entire front seat 7 in the longitudinal direction of the motor vehicle 1. The support structure 42 of the seat back 10 is joined with the support structure 42 of the seat bottom 9 by means of connecting parts that are not shown, so that both the seat bottom 9 and seat back 10 also move together horizontally during the horizontal movement of the front seat 7.

The seat bottom 9 of the front seat 7 exhibits a seat surface 14 for an individual to sit on, and the seat back 10 of the front seat 7 as a seat 6 exhibits a back surface 15 against which to rest the back of an individual on the seat 6. The back surface 15 simultaneously forms a front side 16 of the seat back 10. The seat back 10 also exhibits a back side 17 opposite the front side 16. The seat back 10 is pivoted around a swivel axis 18 relative to the remaining motor vehicle 1, as well as to the seat bottom 9. Individuals or passengers on the rear seats 8 are arranged in proximity to or on the back side 17 of the seat back 10 in the area of their knees, so that an area or partial area on the back side 17 yields legroom 43, and the knees of individuals on the rear seats 8 are arranged within the leg room 43.

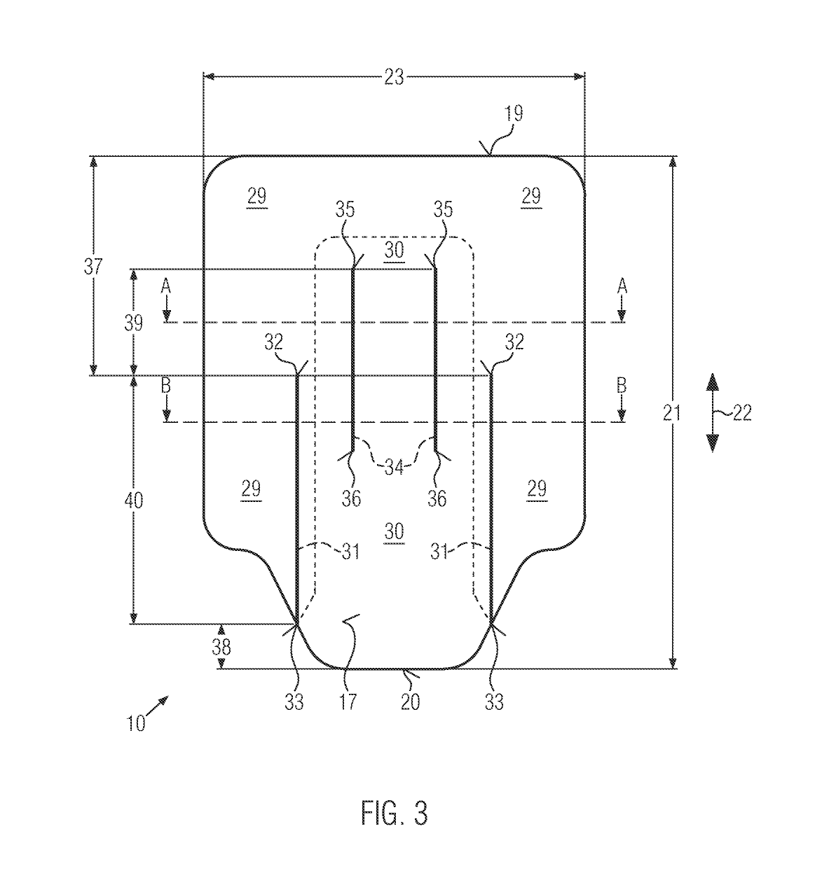

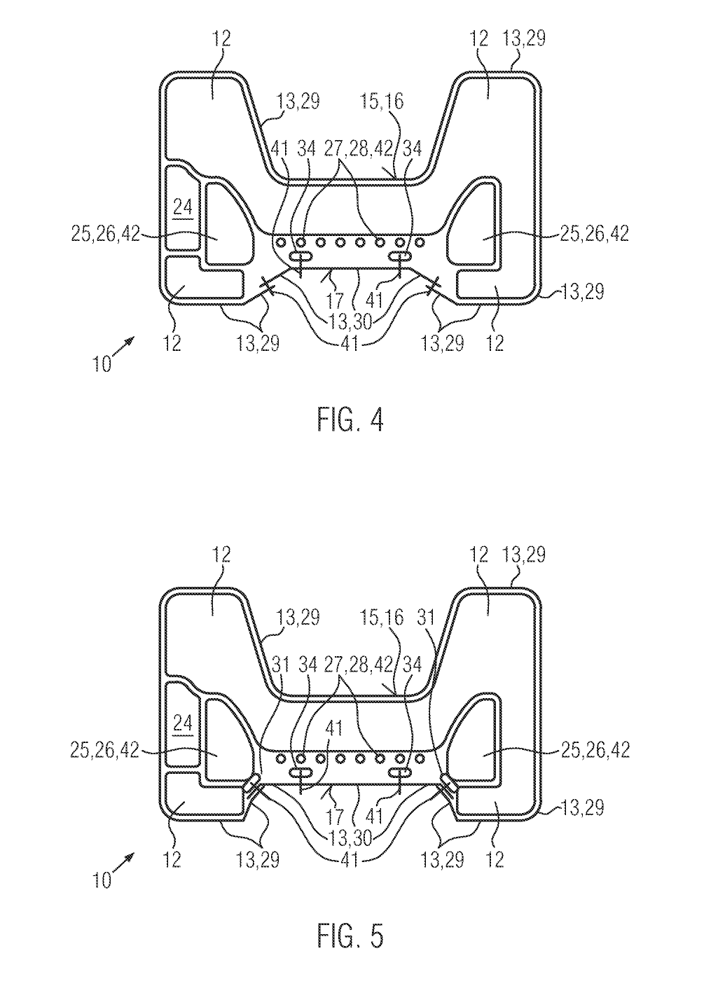

The seat back 10 exhibits an upper end 19 and a lower end 20. There is a height extension 21 of the seat back 10 between the upper end 19 and lower end 20 (FIGS. 2 and 3). A direction 22 of the height extension 21 is aligned parallel to the height extension 21. The seat back 10 also exhibits a width expansion 23, and the width extension 23 is aligned perpendicular to the height extension 21. The support structure 42 of the seat back 10 is divided into an A-support structure 25 as a strut 26 made out of metal, in particular steel or aluminum, and a B-support structure 27 as a wire frame 28 (FIGS. 4 and 5). The seat cover 13 rests on the upholstery 112 included of foam, and the seat cover 13 is here divided into an A-section 29 and B-Section 30. The A-section 29 forms the back surface 15, and the B-section 30 borders the back side 17 of the seat back 110. The A-section 29 is further also guided around the lateral areas of the seat back 10, and also rests against an airbag module 24, and further against upholstery 12 on the back side 17, so that the A-section 29 of the seat cover 13 also partially forms or borders the back side 17 of the seat back 10. The B-section 30 of the seat cover 13 exclusively forms the back side 17 of the seat back 10. In the horizontal section depicted on FIGS. 4 and 5 or the section perpendicular to the direction 22 of the height extension 21, the B-section 30 of the seat cover 13 exhibits two lateral end areas. The A-section 29 of the seat cover 30 guided around the lateral areas of the seat back 10 also exhibits two end areas.

Two A-fixing strips 31 made out of plastic are arranged on a back area of the seat back 10. Two B-fixing strips 34 are also further arranged on the back area of the seat back 10. The A-fixing strips 31 and B-fixing strips 34 are arranged under the seat cover 13, and thus only shown by dotted lines in the back view on FIG. 3, since the latter are consequently not directly visible on the back side 17. The A-fixing strip 31 made out of plastic exhibits an upper end 32 and lower end 33. The B-fixing strip 34 exhibits an upper end 35 and lower end 36. The A-fixing strip 31 exhibits a length 40. A distance 37 between the two upper ends 32 of the A-fixing strips 31 and the upper end 19 of the seat back 10 here measures 55% of the height extension 21 as the overall height extension 21 of the seat back 10 between the upper end 19 and lower end 20 of the seat back 10. The two A-fixing strips 31 and two B-fixing strips 34 are aligned essentially parallel to the direction 22. Given the distance 37 between the two upper ends 32 of the A-fixing strips 31 and the upper end 19 of the seat back 10, the two A-fixing strips 31 are arranged outside the legroom 43 on the back side 17 of the seat back 10. Therefore, if the knee of an individual rests against the back seat 8 on the back side 17, meaning against the B-section 30 of the seat cover 13 between the A-fixing strips 31, the knee is arranged over the upper ends 32 of the A-fixing strips 31, and can as a result not come into indirect contact with the A-fixing strips 31. Outside the legroom 43, meaning in a section according to FIG. 5, a respective end area of the A-section 29 of the seat cover 13 with a respective one end area of the B-section 30 of the seat cover 13 is joined with an A-fixing strip 31 by means of a seam 41. According to the depiction on FIG. 5, two A-fixing strips 31 are thus required for joining the end areas of the A- and B-section 29, 30 of the seat cover 13 with each other. As a consequence, the section on FIG. 5 is arranged outside of the legroom 43, and the section on FIG. 4 is arranged within the legroom 43.

The two B-fixing strips 34 may be fastened by hooks or similar fasteners (not shown) as a connector to the B-support structure 27 as the wire frame 28, i.e., to the wire frame 28. The B-section 30 of the seat cover 13 is joined by means of a seam 41 with the B-fixing strips 34. As a consequence, the two B-fixing strips 34 are used to fasten the B-section 30 of the seat cover 13 to the wire frame 28 at a slight distance.

A distance 38 between the lower end 33 of the A-fixing strips 31 and the lower end 20 of the seat back 10 measures 5% of the height extension 21 of the seat back 10. The two upper ends 35 of the B-fixing strips 34 are arranged above the two upper ends 32 of the A-fixing strips 31, and a differential pitch 39 between the upper ends 32 of the A-fixing strips 31 and the upper ends 35 of the B-fixing strips 34 measures 10% of the height extension 21 of the seat back 110.

Viewed as a whole, significant advantages are associated with the seat 6 according to the present disclosure and an associated motor vehicle 1 including the seat 6 according to the present disclosure. The two A-fixing strips 31 exhibit a smaller distance from the lateral surfaces of the seat back 10 than the two B-fixing strips 34. The two B-fixing strips 34 are thus arranged in the direction of a width extension 23 between the A-fixing strips 31, and the upper ends 32 of the A-fixing strips 31 end under the legroom 43 on the back side 17 of the seat back 10, so that the knees of individuals or passengers on the rear seats 8 cannot come into indirect contact with the A-fixing strips 31. This makes it possible to significantly increase comfort as regards legroom 43, since the A-fixing strips 31 are not arranged in the legroom 43 as an uncomfortable stop.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents

1-15. (canceled)

16. A seat for a motor vehicle comprising:
a seat bottom;
a seat back having an A-support structure, a B-support structure, an upholstery, and a seat cover having an A-section laying at least partially on the upholstery, and a B-section fastened at least partially to the B-support structure, wherein the seat back exhibits a height extension between an upper end and lower end thereof; and
at least one A-fixing strip arranged on a back area of the seat back, and fastened to the A-section and B-section of the seat cover, and the A-fixing strip exhibits an upper end and lower end;
wherein a distance in the direction of the height extension between an upper end of the at least one A-fixing strip and the upper end of the seat hack is greater than 40% of the height extension for providing legroom on a hack side of the seat back without the at least one A-fixing strip.

17. The seat according to claim 16, wherein the distance in the direction of height extension between the upper end of the at least one A-fixing strip and the upper end of the seat back is greater than 70% of the height extension of the seat back.

18. The seat according to claim 16, further comprising a plurality of A-fixing strips, each A-fixing strip being arranged on a back area of the seat back, and fastened to the A-section and B-section of the seat cover and exhibiting an upper end and lower end, wherein the distance in the direction of height extension between the upper end of the at least one A-fixing strip and the upper end of the seat back is greater than 40% of the height extension of the seat back for each A-fixing strips.

19. The seat according to claim 18, wherein the distance in the direction of height extension between the upper end of the at least one A-fixing strip and the upper end of the seat back is greater than 70% of the height extension of the seat back for each A-fixing strips.

20. The seat according to claim 16, wherein the length of the at least one A-fixing strip is greater than 20% of the height extension of the seat back, and wherein at least one of an end area of the A-section of the seat cover and an end area of the B-section of the seat cover are fastened to the at least one A-fixing strip.

21. The seat according to claim 16, wherein the length of the at least one A-fixing strip is less than 70% of the height extension of the seat back, and wherein the distance in the direction of height extension between the lower end of the at least one A-fixing strip and the lower end of the seat back is less than 30% of the height extension of the seat back.

22. The seat according to claim 21, wherein the length of the at least one A-fixing strip is less than 30% of the height extension of the seat back, and wherein the distance in the direction of height extension between the lower end of the at least one A-fixing strip and the lower end of the seat back is less than 2% of the height extension of the seat back.

23. The seat according to claim 16, wherein the at least one A-fixing strip is fastened to at least one of the upholstery and the A-support structure, and wherein the at least one A-fixing strip is arranged between the seat cover and upholstery.

24. The seat according to claim 16, wherein the seat back comprises two A-fixing strips arranged in a spaced relation at a distance in the direction of a width extension of the seat back.

25. The seat according to claim 16, wherein the seat back further comprises at least one B-fixing strip, wherein the B-section of the seat cover is fastened to the at least one B-fixing strip.

26. The seat according to claim 25, wherein the B-section of the seat cover is joined with the B-fixing strip by a seam.

27. The seat according to claim 25, wherein the at least one B-fixing strip is fastened to the B-support structure.

28. The seat according to claim 25, wherein an upper end of the at least one B-fixing strip ends in a differential pitch in the direction of the height extension relative to the upper end of the at least one A-fixing strip.

29. The seat according to claim 28, wherein the upper end of the B-fixing strip ends above the upper end of the A-fixing strip.

30. The seat according to claim 28, wherein the differential pitch is greater than 2% of the height extension of the seat back.

31. The seat according to claim 30, wherein the differential pitch is greater than 30% of the height extension of the seat back.

32. The seat according to claim 16, wherein the A-section and the B-section of the seat cover are fastened to the A-fixing strip by a seam.

33. The seat according to claim 16, wherein the A-support structure comprises two metal struts, and the B-support structure comprises a wire frame formed in a direction of the width extension of the seat back between the A-support structure in a section transverse to the direction of the height extension of the seat back.

34. The seat according to claim 33, wherein the seat back is configured to pivot around a swivel axis.

35. A motor vehicle comprising a body, a drivetrain, and at least one seat formed according to claim 16.
